(19) United States
(12) Patent Application Publication
(10) Pub. No.: US 2006/0156895 A1
(43) Pub. Date: Jul. 20, 2006

(54) Flexible guitar pick

(76) Inventors: Brian Thomas Judd, Campbell, CA (US); Spencer Thomas Judd, Campbell, CA (US)

Correspondence Address: Brian Judd, #2, 1663 Whitwood Ln, Campbell, CA, 95008, US

(21) Appl. No.: 11/332,933

(22) Filed: Jan. 17, 2006

Related U.S. Application Data
(60) Provisional application No. 60/644,971, filed on Jan. 18, 2005.

(51) Int. Cl. G10D 3/16

(52) U.S. Cl. 84/320

(57) ABSTRACT

A flexible guitar pick is provided, wherein there is a cutout section that traverses the center of the pick to create a hinge point at each side of the pick allowing the pick to have extreme flexibility when strumming. Furthermore by choking up on the pick with the players' finger the forward half of the pick can be used to employ the full rigidity of the front portion of the pick.

### CROSS-REFERENCE TO RELATED APPLICATIONS

The present Utility patent application claims priority to the provisional application for patent having the application Ser. No. of 60/644,971 and was filed on Jan. 18, 2005.

### FIELD OF THE INVENTION

The present invention relates generally to picks for stringed musical instruments. More particularly, the invention relates to stringed musical instrument picks having flexible construction features.

### BACKGROUND OF THE INVENTION

It has long been a problem for stringed musical instruments (e.g., guitar) players to get an even strum across the strings of the instrument without extreme articulation of the wrist. Musicians of stringed instruments such as, for example, guitars, banjos, ukuleles, bass, and harps, commonly use picks to strum. A common problem for conventional picks is that they build pressure during strumming as they make contact with the first string, and then push the users hand away as they snap through the remaining strings. This creates a louder sound from the outermost strings compared to those in the center of the instrument.

Traditional picks are usually flat, made of relatively stiff materials, and may be die cut or injection molded to achieve a desired shape. The stiffness of traditional picks will determine to an extent the volume of the instrument when strummed. A problem created when using a thick pick is that there is a torque created that tends to leverage the pick to leave the fingers unexpectedly. To make strumming easier and create a more even sound a very thin and flexible pick must be used. The problem with the use of the thin pick is that although there is enough flexibility to strum evenly, there is not enough rigidity at the tip of the pick to achieve an acceptable volume.

In view of the foregoing, there is a need for improved techniques for constructing stringed musical instrument picks. For example, it would be desirable for an improved pick design that would allow improved flexibility and even strumming while having enough rigidity to produce adequate volume. It would be further desirable to allow the musician to grip the pick in a way to circumvent the flexible feature and have a rigid pick for individual note picking. Moreover, it would be helpful if as the thickness of the pick changed, these improvements are not lost or degraded.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a front side view of an instance of a first embodiment of a teardrop shaped pick, wherein a curved cutout traverses the pick leaving a connecting amount of material on each side of the pick;

FIG. 2 illustrates an angled view of an instance of the first embodiment;

FIG. 3 illustrates an angled view of an instance of the first embodiment, wherein the pick is in a flexed position;

FIG. 4 illustrates a front side view of an instance of a second embodiment of a teardrop shaped pick, wherein a straight cutout traverses the pick leaving a connecting amount of material on each side of the pick.

### SUMMARY OF THE INVENTION

To achieve the forgoing and other objects and in accordance with the purpose of the invention, a variety of techniques are described to achieve a flexible guitar pick.

The present invention, generally speaking, provides for a flexible guitar pick comprising a pick surface having a cut-out formed crosswise of a tip of the pick, the cut-out defining flex points at opposite side edges of the pick. The cut-out may be straight. More preferably, the cut-out is curved to prevent interference with the thumb or fingers during flexing of the pick.

In other aspects of the invention, a pick for strumming a stringed musical instrument includes a pick surface having a tip portion, a grip surface, and a straight or curvilinear cut extending crosswise of the tip portion, whereby increased flexion is achieved between the pick surface and the grip surface. The cut may be a through-cut extending through the pick and may be curvilinear. Preferably a curve of the cut is arranged to cup a user's thumb during use. In an exemplary embodiment, the cut is slot-shaped and extends from near one edge of the pick to near an opposite edge of the pick.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

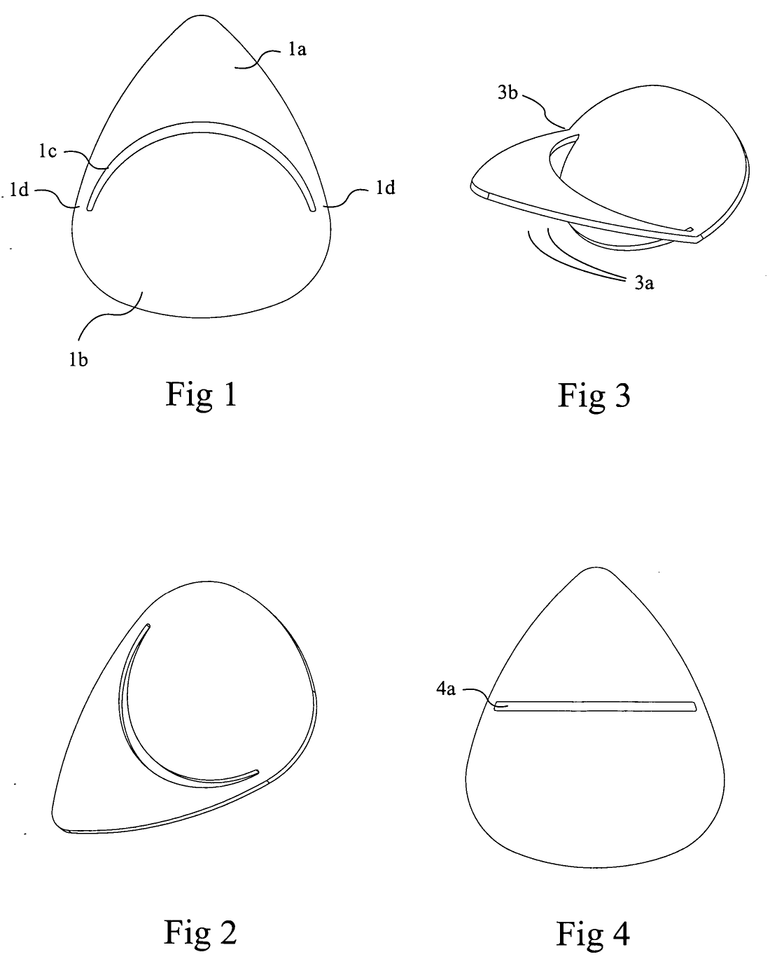

FIG. 1 through 4 show embodiments of the pick wherein the pick is generally tear drop shaped.

In a preferred embodiment, the cutout FIG. 1c is formed to be curved to match the shape of a thumb, whereby musicians will typically hold the present pick at a perpendicular or 45 degree angle to the thumb with respect to the length of the pick, with the index finger simultaneously gripping the backside of the present pick.

The cutout creates flex points 1d and 3b allowing the tip portion of the pick 1a to flex 3a and change its angle relative to the grip portion of the pick 1b as it traverses the strings of the guitar. This embodiment further allows the user to move their finger and thumb over the cutout area 1c thus employing more directly the tip portion 1a of the pick when it is needed to circumvent the flexible design of the pick.

FIG. 4 shows an embodiment wherein the cutout is straight 4a.

Pick embodiments according to the present invention may be constructed in any known way as will be apparent by those skilled in the art, by way of example, and not limitation, suitable fabrication techniques include injection molding with commonly used pick materials or they may be compression formed and cut. Embodiments of the present invention may be constructed of relatively stiff or relatively flexible materials. Known materials that achieve a relatively stiff pick include polycarbonates, acetal (e.g., by Delrin ™), or nylon.

The compliant embodiment of the present invention may be constructed according to known methods including but not limited to, injection molding and thermoforming.

Alternative embodiments of the present invention may include a raised texture on contact surface(s) of the pick to further enhance the feel and grip of the pick by the musician (e.g., a raised hatch patter). Moreover, embodiments of the present invention may be formed in a multiplicity of suitable shapes depending on the needs of the particular application. Some common suitable shapes include, but are not limited to, triangle, tear drop, and Jazz style. Those skilled in the art will recognize how to adapt any suitable conventional pick to incorporate the teachings of the present invention. Embodiments of the present picks may be constructed to have any suitable thickness depending on the needs of the particular application.

Having fully described at least one embodiment of the present invention, other equivalent or alternative methods of providing a flexible guitar pick according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A pick for strumming a stringed musical instrument, comprising:
a pick surface having a tip portion;
a grip surface; and
a straight or curvilinear cut extending crosswise of the tip portion, whereby increased flexion is achieved between the pick surface and the grip surface.

2. The pick of claim 1, wherein the cut is a through-cut extending through the pick.

3. The pick of claim 1, wherein the cut is curvilinear.

4. The pick of claim 3, wherein a curve of the cut is arranged to cup a user's thumb during use.

5. The pick of claim 1, wherein the cut is slot-shaped.

6. The pick of claim 1, wherein the cut extends from near one edge of the pick to near an opposite edge of the pick.

7. A pick for a stringed instrument comprising a surface having a cut-out formed crosswise of a tip of the pick, the cut-out defining flex points at opposite edges of the pick.

8. The pick of claim 7, wherein the cut-out is straight.

9. The pick of claim 7, wherein the cut-out is curved to prevent interference with the thumb or fingers during flexing of the pick.
